(19) United States
(12) Patent Application Publication
(10) Pub. No.: US 2012/0040227 A1
(43) Pub. Date: Feb. 16, 2012

(54) ENERGY STORAGE MODULE

(75) Inventors: Young Hak JEONG, Gunpo (KR); Yong Wook Kim, Suwon (KR); Bae Kyun Kim, Seongnam (KR); Hyun Chul Jung, Yongin (KR)

(73) Assignee: SAMSUNG ELECTRO-MECHANICS CO., LTD.

(21) Appl. No.: 13/025,840

(22) Filed: Feb. 11, 2011

(30) Foreign Application Priority Data
Aug. 13, 2010 (KR) 10-2010-0078494

(51) Int. Cl. H01M 10/50

(52) U.S. Cl. 429/120

(57) ABSTRACT

There is provided an energy storage module including, a plurality of energy storage units having electrodes connected in series or in parallel, one or more cooling plates provided to alternate with the energy storage units, each having a flow path through which cooling water flows, so as to cool the energy storage units, and a housing surrounding the energy storage units and the cooling plates and including an inlet and an outlet through which the cooling water is drawn and discharged to thereby provide the cooling water to the cooling plates.

### CROSS-REFERENCE TO RELATED APPLICATIONS

This application claims the priority of Korean Patent Application No. 10-2010-0078494 filed on Aug. 13, 2010, in the Korean Intellectual Property Office, the disclosure of which is incorporated herein by reference.

### BACKGROUND OF THE INVENTION

1. Field of the Invention

The present invention relates to an energy storage module, and more particularly, to an energy storage module capable of increasing the lifespan and efficiency thereof by cooling energy storage units.

2. Description of the Related Art

In general, an energy storage device is a device storing electrical energy therein and providing the electrical energy to the outside when necessary. Recently, a secondary battery (a Ni—MH battery, a Li ion battery (LiB) or the like) or an electrochemical capacitor (a supercapacitor) has been used as this energy storage device.

This second battery such as a Li ion battery is a representative energy storage device having high energy density. However, while the secondary battery has a more limited output characteristic than the super capacitor, the super capacitor is a high output storage device but has lower energy density than the secondary battery (i.e., Li ion battery).

Thus, in order to solve the limitations of the super capacitor and the secondary battery, the development of an energy storage module providing a large amount of energy and improving the output characteristics thereof by electrically connecting a plurality of energy storage devices (in series or in parallel) has been increasing.

In this energy storage module, one of the important factors enabling the energy storage module to provide a large amount of energy and to improve the output characteristics thereof is a factor associated with cooling.

The cooling system of an energy storage module in the related art employs a heat sink system using air-cooling, and requires the mounting of an additional cooling fan on the outside of the energy storage module.

However, the additional cooling fan has a defect in that the difference of temperature distribution inside the energy storage module is increased depending on the formation location of the cooling fan.

Moreover, when the energy storage module is placed in a closed environment, the temperature inside the energy storage module does not fall, in spite of the cooling by the cooling fan.

Thus, a study to improve the thermal characteristics of an energy storage module by maximizing the cooling efficiency thereof is required.

### SUMMARY OF THE INVENTION

An aspect of the present invention provides an energy storage module having increased stability and lifespan by enhancing the thermal characteristics thereof through the improvement of a cooling structure thereof.

According to an aspect of the present invention, there is provided an energy storage module including a plurality of energy storage units having electrodes connected in series or in parallel; one or more cooling plates provided to alternate with the energy storage units, each having a cooling flow path through which cooling water flows, so as to cool the energy storage units; and a housing surrounding the energy storage units and the cooling plates and including an inlet and an outlet through which the cooling water is drawn and discharged to thereby provide the cooling water to the cooling plates.

The electrodes and the one or more cooling plates may be spaced apart from each other, in order to prevent a contact therebetween.

The electrodes may be formed on a surface of each of the energy storage units, and the cooling plates have a height lower than that of the surface of each of the energy storage units having the electrodes formed thereon, to thereby prevent the electrodes and the cooling plates from contacting each other.

Each of the energy storage units may include a single energy storage device or a plurality of energy storage devices.

The inlet and the outlet may communicate with the cooling water path.

The energy storage units and the cooling plates may be positioned to be in contact with each other.

The housing and the cooling plates may be integrated.

The housing may include a body part accommodating the energy storage units and a covering part sealing the body part.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view illustrating an energy storage module according to an exemplary embodiment of the present invention;

FIG. 2 is a schematic exploded perspective view illustrating an energy storage module according to an exemplary embodiment of the present invention;

FIG. 3 is a schematic cross-sectional view illustrating an energy storage module according to an exemplary embodiment of the present invention (cross-sectional view taken along line A-A′ in FIG. 1); and

FIG. 4 is a schematic perspective view illustrating the flow of cooling water within an energy storage module according to an exemplary embodiment of the present invention (cut-away perspective view taken along line B-B′ in FIG. 3).

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. While those skilled in the art could readily devise many other varied embodiments that incorporate the teachings of the present invention through the addition, modification or deletion of elements, such embodiments may fall within the scope of the present invention.

The same or equivalent elements are referred to by the same reference numerals throughout the specification.

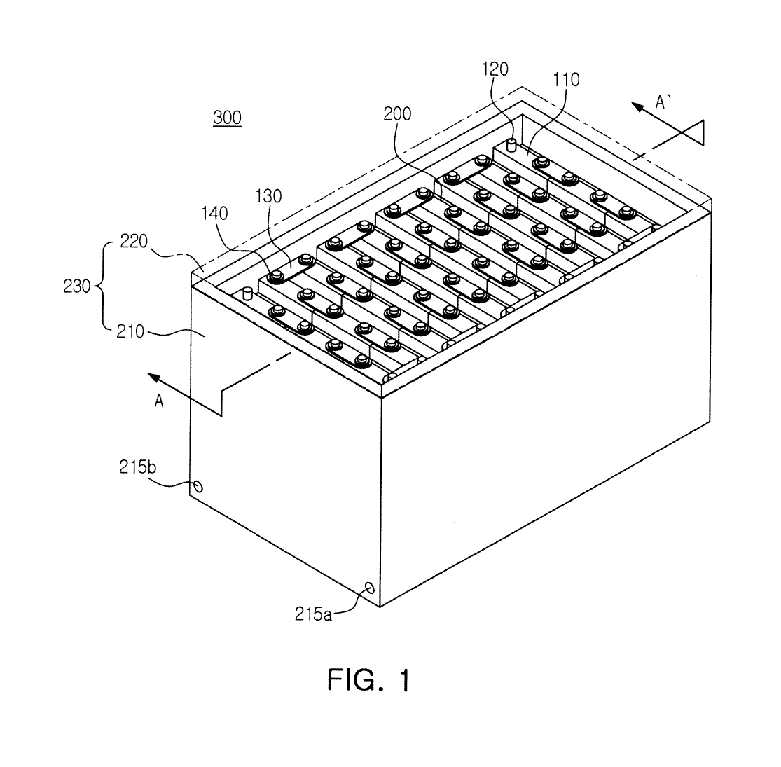

FIG. 1 is a schematic perspective view illustrating an energy storage module according to an exemplary embodiment of the present invention.

Referring to FIG. 1, an energy storage module 300 according to an exemplary embodiment of the present invention may include energy storage units 100, a housing 230, and cooling plates 200.

Each of the energy storage units 100 is a device storing electrical energy therein and providing the electrical energy to the outside when necessary. The energy storage unit may be a secondary battery (a Ni—MH battery, a Li ion battery (LiB) or the like) or an electrochemical capacitor (a super capacitor).

However, the energy storage unit 100 is not limited thereto and may include any kind of devices capable of storing electrical energy therein and providing the electrical energy to the outside.

The energy storage unit 100 may include electrodes 120, and each of the electrodes 120 may be an anode electrode or a cathode electrode.

The anode electrode or the cathode electrode of one energy storage unit may be connected with an anode electrode or a cathode electrode of another energy storage unit adjacent thereto by a terminal connection member 130, to be described below. In other words, the terminal connection member 130 is coupled to one of the electrodes 120 of the energy storage unit 100 and one of the electrodes 120 of another energy storage unit adjacent thereto, and may electrically connects a plurality of energy storage units 100 in series or in parallel.

The plurality of energy storage units 100 electrically connected in series or in parallel by the terminal connection member 130 may provide a large amount of energy, and improve the output characteristics of the energy storage module 300.

The housing 230 may be configured to have a covering part 220 and a body part 210 and may form the exterior of the energy storage module 300.

The cooling plates 200, to be described below, are included inside the body part 210 and form partitions inside the body part 210.

In addition, the lateral surfaces of the cooling plates 200 may entirely come into contact with the lateral surfaces of the energy storage units 100. Thus, the cooling plates 200 may function as cooling devices cooling the energy storage units 100.

Here, besides the function of cooling the energy storage units 100, the cooling plates 200 may stably fasten the energy storage units 100 within the body part 210 because they form partitions inside the body part 210.

Therefore, the energy storage module 300 may be prevented from being broken due to external impacts or vibrations, thereby enabling the lifespan of the energy storage module 300 to be extended.

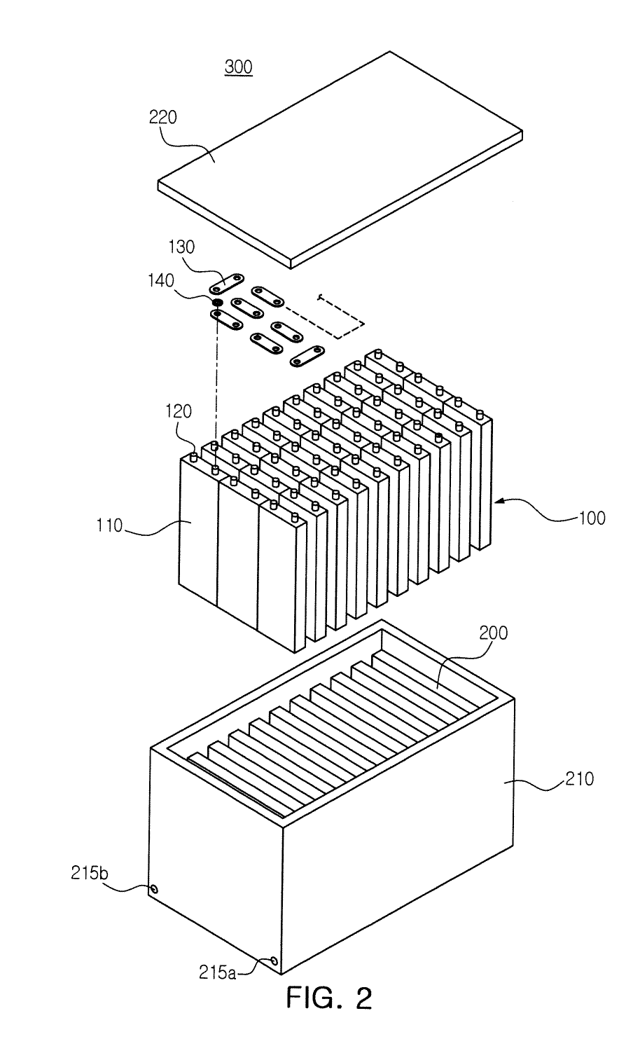

The energy storage module 300 and elements forming the energy storage module 300 will be described in detail with reference to FIGS. 2 through 4.

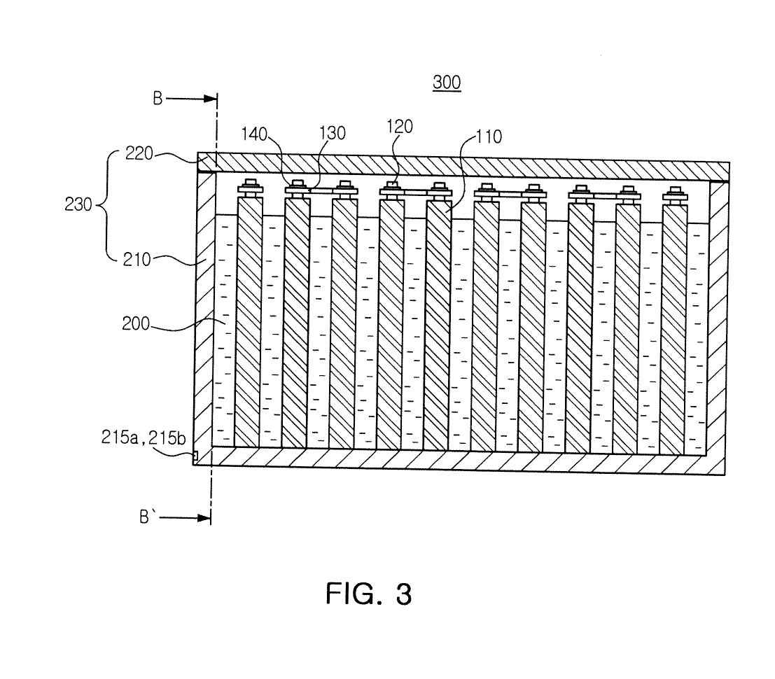

FIG. 2 is a schematic exploded perspective view illustrating an energy storage module according to an exemplary embodiment of the present invention. FIG. 3 is a schematic cross-sectional view illustrating an energy storage module according to an exemplary embodiment of the present invention (cross-sectional view taken along line A-A′ in FIG. 1).

Referring to FIGS. 2 and 3, the energy storage module 300 according to an exemplary embodiment of the present invention may include the energy storage units 100, the housing 230 and the cooling plates 200, as described above.

The energy storage unit 100 may be a single energy storage device and may be a plurality of energy storage devices so as to provide a large amount of energy.

At this time, each of the anode electrodes and cathode electrodes of the energy storage unit 100 may be connected by the above mentioned terminal member 130.

That is, the number of energy storage devices forming the energy storage units 100 is not limited and may be changed by a person skilled in the art.

The energy storage unit 100 may be configured to have a storage body 110 and the electrodes 120. The terminal connection member 130 and fixing members 140 may be included in order to electrically connect the plurality of energy storage units 100.

A device capable of storing energy is included inside the storage body 110. In the case in which the energy storage unit 100 is an electrochemical capacitor (a super capacitor), an electric double layer, or the like may be formed inside the storage body thereof.

The electrodes 120 are formed on a surface of the storage body 110 and may be outwardly protruded from the surface of the storage body 110.

Here, the electrodes 120 may be terminals electrically connected with current collectors (not shown) of anode and cathode plates, which are included in the storage body 110.

The electrodes 120 formed on the plurality of energy storage units 100 may be electrically connected by the terminal connection members 130. The terminal connection members 130 may have insertion holes into which the electrodes 120 protruded from the one surface of the storage body 110 are inserted.

Thus, the electrodes 120 are inserted into the insertion holes, so that the plurality of energy storage units 100 may be electrically connected.

The electrodes 120 are inserted into the insertion holes of the terminal connection member 130, and the fixing members 140 may be included to fix the terminal connection member 130 to the electrodes 120.

The fixing members 140 are members which come into contact with a surface of the terminal connection member 130. After the electrodes 120 are inserted into the terminal connection member 130, the terminal connection member 130 is coupled to the electrodes 120 by the fixing members 140.

Therefore, the terminal connection member 130 is stably fixed to the electrodes 120 by the fixing members 140.

However, the outermost electrodes may not need the terminal connection members 130 so as to be electrically connected with the terminals (not shown) of an external power input device. The outermost electrodes may supply power to the energy storage module 300.

Here, the fixing member 140 is explained as a ring-shaped member; however which is not limited thereto. Any coupling part will be used so long as it can fix the terminal connection member 130 to the electrodes 120, such as a screw or the like.

The housing 230 forms the exterior of the energy storage module 300 and may include the covering part 220 and the body part 210.

The cooling plates 200 cooling the energy storage units 100 are included inside the body part 210 and may form the partitions inside the body part 210.

That is, the energy storage units 100 are inserted between the cooling plates 200 which form the partitions inside the body part 210. The lateral surfaces of energy storage units 100 may come into contact with the lateral surfaces of the cooling plates 200.

In other words, the cooling plates 200 may be cooling devices, provided to alternate with the energy storage units 100 and cooling the energy storage units 100.

Inside each of the cooling plates 200, a flow path through which cooling water flows may be formed. The flow path may have a curved pipe or tube shape or a void space.

An inlet 215a, into which cooling water cooling the energy storage units 100 flows, may be formed in the body part 210. The cooling water is drawn from the inlet 215a and flows into the inside of the cooling plates 200.

Thus, the body part 210 and the cooling plates 200 are communicated with each other, and the cooling water drawn from the inlet 215a flows into the inside of the cooling plates 200.

In addition, the cooling water is drawn from the inlet 215a, discharged to the outside through an outlet 215b formed in the side surface of the body part 210, and circulated by a cooling water circulating device (not shown) located outside the energy storage module 300.

Thus, low-temperature cooling water flows into the inlet 215a, passes through the cooling plates 200, absorbs the heat of the energy storage units 100, and flows out to the outlet 215b.

At this time, a device allowing for such operations may be the cooling water circulating device.

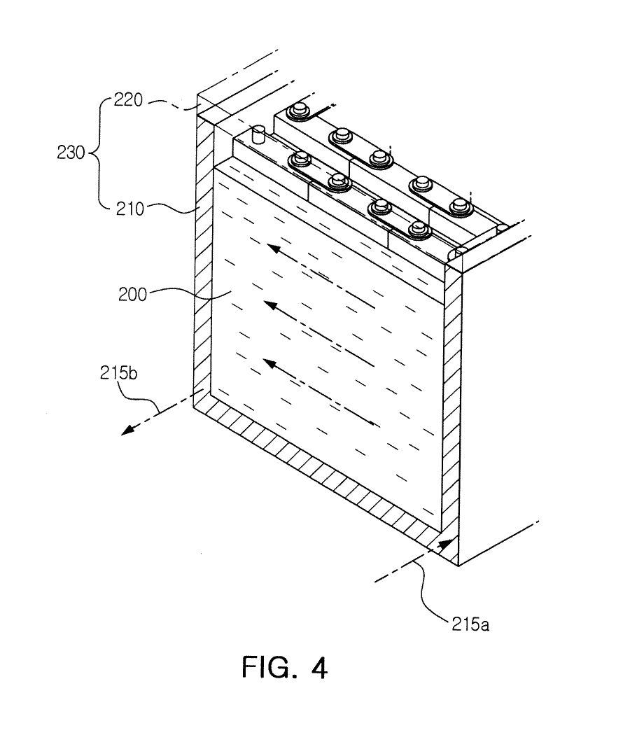

The flow of the cooling water will be explained in detail with reference to FIG. 4.

The cooling plates 200 may have a height lower than that of the surface of the energy storage unit 10, on which the electrodes 120 are formed. This is to prevent the cooling water from coming into contact with the electrodes 120.

Each of the cooling plates 200 are placed at a predetermined distance apart from the electrodes 120 in order that the cooling water flowing through the flow path inside the cooling plate 200 may be prevented from coming into contact with the electrodes 120. Namely, this is to enhance the performance of the energy storage module 300.

Here, the cooling plates 200 may be integrated with the body part 210 of the housing 230. A contact surface of the body part 210 and the cooling plates 200 is communicated, thereby allowing the cooling water to flow therethrough.

FIG. 4 is a schematic perspective view illustrating the flow of cooling water within an energy storage module according to an exemplary embodiment of the present invention (cut-away perspective view taken along line B-B′ in FIG. 3).

Referring to FIG. 4, when cooling water flows into the inlet 215a formed in the side surface of the body part 210 of the housing 230, the cooling water passes through the cooling plates 200.

At this time, the later surfaces of the cooling plates 200 entirely come into contact with the lateral surfaces of the energy storage units 100, such that the cooling water absorbs the heat of the energy storage units 100.

This cooling water absorbing the heat is discharged to the outside through the outlet 215b formed on the side surface of the body part 210. The cooling water circulating device allows low temperature cooling water to flow into the inlet 215a again.

Thus, the energy storage module 300 according to an exemplary embodiment of the present invention may allow the heat to be effectively radiated outside through the cooling plates 200 which entirely come into contact with the lateral surfaces of the storage bodies 110 of the energy storage units 100.

In other words, the energy storage module 300 according to an exemplary embodiment of the present invention may obtain such results by employing a water cooling system cooling the energy storage units 100 by using cooling water.

Through the above embodiments, the energy storage module 300 according to an exemplary embodiment of the present invention extends contact areas of the energy storage units 100 and the cooling plates 200 and uses a cooling water system, so that the cooling efficiency thereof could be maximized.

The cooling plate 200 has a function of cooling the energy storage unit 100. Also, the cooling plate 200 may stably fasten the energy storage units 100 within the body part 210 because they form partitions inside the body part 210.

Therefore, the energy storage module may be prevented from being broken due to external impacts or vibrations, thereby enabling the lifespan of the energy storage module 300 to be extended.

As set forth above, according to exemplary embodiments of the invention, there is provided an energy storage module capable of increasing the lifespan and the stability thereof by increasing the cooling efficiency thereof.

In addition, the energy storage module can be prevented from being broken due to vibrations and impacts because energy storage units forming the energy storage module can be fixed therein.

While the present invention has been shown and described in connection with the exemplary embodiments, it will be apparent to those skilled in the art that modifications and variations can be made without departing from the spirit and scope of the invention as defined by the appended claims.

What is claimed is:

1. An energy storage module comprising,
a plurality of energy storage units having electrodes connected in series or in parallel;
one or more cooling plates provided to alternate with the energy storage units, each having a cooling flow path through which cooling water flows, so as to cool the energy storage units; and
a housing surrounding the energy storage units and the cooling plates and including an inlet and an outlet through which the cooling water is drawn and discharged to thereby provide the cooling water to the cooling plates.

2. The energy storage module of claim 1, wherein the electrodes and the one or more cooling plates are spaced apart from each other, in order to prevent a contact therebetween.

3. The energy storage module of claim 1, wherein the electrodes are formed on a surface of each of the energy storage units, and the cooling plates have a height lower than that of the surface of each of the energy storage units having the electrodes formed thereon, to thereby prevent the electrodes and the cooling plates from contacting each other.

4. The energy storage module of claim 1, wherein each of the energy storage units comprises a single energy storage device or a plurality of energy storage devices.

5. The energy storage module of claim 1, wherein the inlet and the outlet communicate with the cooling water path.

6. The energy storage module of claim 1, wherein the energy storage units and the cooling plates are positioned to be in contact with each other.

7. The energy storage module of claim 1, wherein the housing and the cooling plates are integrated.

8. The energy storage module of claim 1, wherein the housing includes a body part accommodating the energy storage units and a covering part sealing the body part.
